(19) United States
(12) Patent Application Publication
(10) Pub. No.: US 2007/0153260 A1
(43) Pub. Date: Jul. 5, 2007

(54) Robot system and method for anode surface inspection and burr elimination in smelting and electrorefining processes

(76) Inventor: Hugo Salamanca, Santiago (CL)

Correspondence Address: Hugo Salamanca P., Av. Suecia 84, Oficina 43, Providencia, Santiago, RM, CL

(21) Appl. No.: 11/598,123

(22) Filed: Nov. 13, 2006

Related U.S. Application Data
(60) Provisional application No. 60/734,972, filed on Nov. 10, 2005.

(51) Int. Cl. G01N 21/88

(52) U.S. Cl. 356/237.1

(57) ABSTRACT

At present, the elimination of burrs has the disadvantage of being carried out manually or in a semiautomatic way which causes the system to be less efficient. Also, the anode surface inspection as it is carried out today has the disadvantage of being visual (by the personnel) in many cases and with low levels of application of advanced vision technologies. Due to the above, a robot system and method have been developed to carry out the elimination process of burrs and the inspection of anode surfaces in an automatic way.

The robotic system is composed mainly of a robotic manipulator (1) of at least 4 degrees of freedom, and a gripping mechanism (2) which allows to take the burr (3) elimination device from a tool holder located at one of its sides, and move it through a defined path to the anode (4), in which a burr elimination process will take place, in a sequential and programmed way, to a certain number of edges and/or faces of the anodes (4) to be defined. Additionally, the configuration of this system allows to carry out an inspection process of the surfaces in a sequential and programmed way through a second robotic manipulator of at least 4 degrees of freedom and a gripping mechanism which allows to take an advanced vision system for the inspection of surfaces from a tool holder

### CROSS-REFERENCE TO RELATED APPLICATIONS

This application claims the benefit of provisional patent application Ser. No. 60/734,972 filed 2005 Nov. 10 by the present inventor

### FEDERAL SPONSORED RESEARCH

Not Applicable

### SEQUENCE LISTING OR PROGRAM

Not Applicable

### BACKGROUND—FIELD OF INVENTION

This invention relates to the use of robotic technology in mining industry, specifically in smelting and electrorefining processes.

### BACKGROUND—PRIOR ART

During metal obtention and refining processes, smelting furnaces are used to cast metal concentrates for purifying and extracting them. The first stage of the productive process is to move the dry concentrate to one of these furnaces, which could be a flash furnace and/or a Teniente converter, where casting is at temperatures over 1.200° C. In this way, while the concentrate becomes a molten liquid mass, its components are being separated and combined then to form a two layer bath. The heaviest layer is called matte and it is a metal enriched component. Over this layer, the slag is floating, which is a coat of impurities of the metal of interest. In this way and during successive stages, the stage rich in the metal of interest is sequentially cast and refined through several furnaces which allows to obtain a high purity metal.

In the last stage of the smelting process, the fire refining stage is carried out in which the metal is processed in rotary furnaces, by adding special purifying agents which are called fluidizing agents to oxide and eliminate all the impurities with the resulting effect of very few non desired elements contained in the molten bath. Then, the oxygen is extracted with steam or oil injections with the final result of a high purity level.

Thus, when a metal load reaches the required purity level, the furnace is inclined and in exact quantities the metal is poured in one of the ingot molds of the fire refined mold casting wheel. Once the metal is poured into the mold, the wheel rotates to advance the following mold to the position and other ingot is molded. In this way, the wheel speed is adjusted in an accurate way to the optimum speed profile, ensuring a smooth acceleration and disacceleration level of the molds. This is intended to produce high quality ingots with a minimum burr formation grade.

To finish the smelting process, the dislodging process (stripping and/or extraction) proceeds in which the molded anodes are lifted and sent to a cooling tank to avoid the excessive oxidation and to obtain a deep scrubbing.

Then, the molded anodes are counted and arranged in predetermined bundles or arranged at distances as required by the electrolytic plant. The discharge of the cooling tanks is carried out by a forklift or anode lifting devices.

Finally the anodes are subjected to a burr elimination process and surface inspection in which it is ensured that the anode has reached a quality surface finish and it is has not ridges and small physical defects. Then the anodes are stored in areas specially designed for this.

Particularly, the task of burr elimination from anodes in the way it is carried out today has the disadvantage of being carried out manually or semi-automatically which causes the system to be less efficient. In turn, the surface inspection has disadvantage of being carried out visually on many occasions or with low levels of advanced vision technologies. Similarly in many cases the operators are subjected to a high physical demand and harsh environmental conditions.

### SUMMARY

A robotic system and method have been developed for the automated elimination of burr and surface inspection of anodes. One robotic manipulator manipulates an advanced vision system for anode surface inspection and second robotic manipulator manipulates burr elimination device.

### DRAWINGS—FIGURES

FIG. 1. General view of a robot system for the elimination of burrs and surface inspection of anodes.

FIG. 2. General view of a robot system for the elimination of burrs and surface inspection of anodes.

### DRAWINGS—REFERENCE NUMERALS

1. Robotic manipulator

2. Gripping mechanism

3. Burr elimination device

4. Anode

### DETAILED DESCRIPTION

This invention relates to a new robot system as well as a robotic method for the elimination of burrs and anodes surface inspection which are carried out automatically through anthropomorphous robotic arms of at least 4 degrees of freedom, which are installed at the storing field.

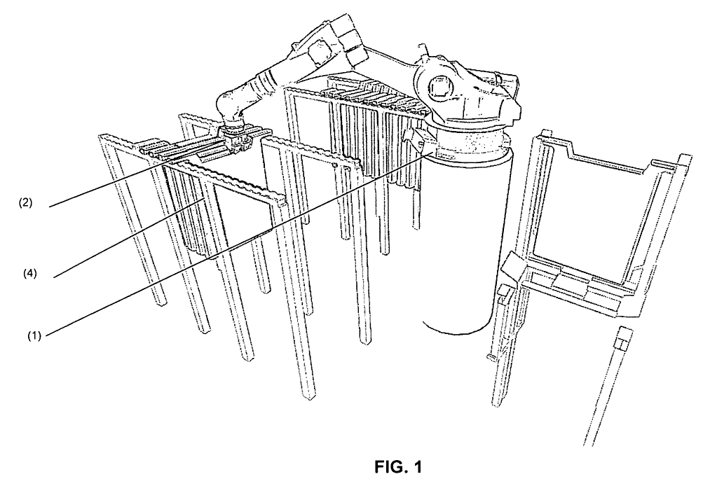

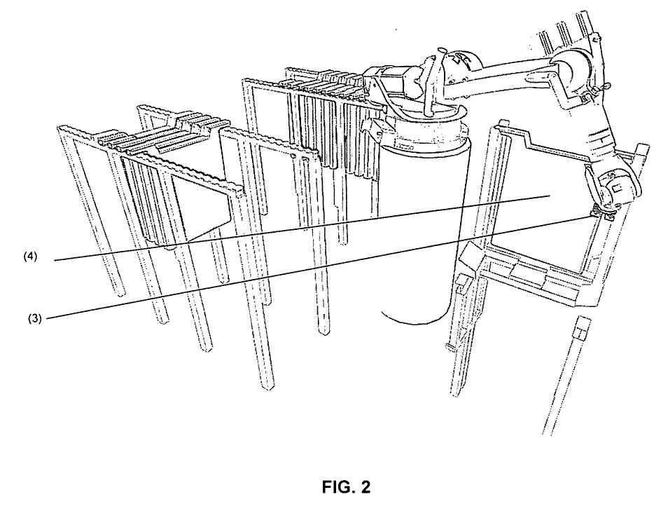

With reference to FIG. 1 and FIG. 2, the robot system is composed mainly of one robotic manipulator (1) of at least 4 degrees of freedom, provided with a communication, acquisition and control system, and a gripping mechanism (2) which allows to take the burr elimination device (3) from a tool holder located at one of its sides, which are moved through a defined path to the anode (4) in which the burr elimination process will take place, in a sequential and programmed way, to a certain amount of anode edges and/or faces to be defined.

Additionally the configuration of this system allows to carry out a surface inspection process in a sequential and programmed way through a second robotic manipulator of at least 4 degrees of freedom and a gripping mechanism which allows to take an advanced vision system for surface inspection from a tool holder

I claim:

1. A robot system for the elimination of burrs and/or surface inspection in anodes in metal smelting and electrorefining processes comprising an anthropomorphous robotic arm of at least 4 degrees of freedom, one control, communication and programming unit, one gripper adapter, one pneumatic gripper mechanism, its fingers, one pneumatic gripper driving system, one electric supply system, one burr elimination device, one advanced vision system for surface inspection and one tool holder wherein the first robotic manipulator of at least 4 degrees of freedom is provided with a gripping mechanism which allows to take, manipulate and release, in a sequential and programmed way, an advanced vision system for anode surface inspection from a tool holder , and moves it through a defined path to the anode in which the surface inspection is carried out in a sequential and programmed way, so as once this task is ended a second robotic manipulator of at least 4 degreed of freedom provided with a gripping mechanism takes, manipulates and releases a burr elimination device from a tool holder located at one of its sides and moves it through defined path to the anode in which the a burr elimination process is carried out in a sequential and programmed way to a certain number of anode burrs and/or faces to be defined.

2. A robot system for the elimination of burrs and/or surface inspection in anodes in metal smelting and electrorefining processes according to claim 1, wherein it allows the technology final user to use the system in a modular way, allowing the carry out the surface inspection and burr elimination in a selective, independent, separate or supplementary way.

3. A robot system for the elimination of burrs and/or surface inspection in anodes in metal smelting and electrorefining processes according to claim 1, wherein it allows the final user of this technology to use one or two of the activities of anode surface inspection and/or burr elimination, in a selective or supplementary way, according to the requirements.

4. A robot system for the elimination of burrs and/or surface inspection in anodes in metal smelting and electrorefining processes according to claim 1, wherein the anthropomorphous robotic manipulator could communicate by itself or through a PLC interface with the control system.

5. A robot system for the elimination of burrs and/or surface inspection in anodes in metal smelting and electrorefining processes according to claim 1, wherein the anthropomorphous robotic manipulator has the capacity to obtain and interpret the information of installed analogue and/or digital sensors.

6. A robot system for the elimination of burrs and/or surface inspection in anodes in metal smelting and electrorefining processes according to claim 1, wherein the anthropomorphous robotic manipulator has the capacity to generate analogue and/or digital signals to control analogue and/or digital input devices.

7. A robot system for the elimination of burrs and/or surface inspection in anodes in metal smelting and electrorefining processes according to claim 1 wherein the anthropomorphous robotic arm of at least 4 degrees of freedom has a pneumatic gripping mechanism which allows to take, manipulate and release an advanced vision system for the surface inspection in different paths within the work volume of the robotic system.

8. A robot system for the elimination of burrs and/or surface inspection in anodes in metal smelting and electrorefining processes according to claim 1, wherein the anthropomorphous robotic arm of at least 4 degrees of freedom has a pneumatic gripping mechanism to take, manipulate and release a burr elimination device.

9. A robot system for the elimination of burrs and/or surface inspection in anodes in metal smelting and electrorefining processes according to claim 1, wherein the anthropomorphous robotic manipulator has an electrical system driven by three-stage induction motors, with vectorial and/or scalar control.

10. A robot system for the elimination of burrs and/or surface inspection in anodes in metal smelting and electrorefining processes according to claim 1, wherein productivity and efficiency of anode surface inspection and burr elimination increases.

11. A robot system for the elimination of burrs and/or surface inspection in anodes in metal smelting and electrorefining processes according to claim 1, wherein it could be integrated not only to anode surface inspection and burr elimination processes of different metals such as copper, zinc, Ni, Fe, etc., but also it could be used for the surface inspection and burr elimination in a selective and supplementary way in a wide range of other industrial productive processes.

12. A robotic system for the elimination of burrs and/or surface inspection in anodes in metal smelting and electrorefining processes according to claim 1, wherein it has the capacity to move and manipulate the different tools in different paths within the work volume of the robotic manipulator.

13. A robotic system for the elimination of burrs and/or surface inspection in anodes in metal smelting and electrorefining processes according to claim 1, wherein the system may operate automatically, semi-automatically and also allows solutions scalability.

14. A robotic method for the elimination of burrs and/or surface inspection in anodes in metal smelting and electrorefining processes using the Robot System of claim 1 to 13, wherein the first robotic manipulator of at least 4 degrees of freedom is provided with a gripping mechanism which allows to take, manipulate and release, in a sequential and programmed way, an advanced vision system for anode surface inspection from a tool holder , and moves it through a defined path to the anode in which the surface inspection is carried out in a sequential and programmed way, so as once this task is ended a second robotic manipulator of at least 4 degreed of freedom provided with a gripping mechanism takes, manipulates and releases a burr elimination device from a tool holder located at one of its sides and moves it through defined path to the anode in which the a burr elimination process is carried out in a sequential and programmed way to a certain number of anode burrs and/or faces to be defined.

15. A robotic method for the elimination of burrs and/or surface inspection in anodes in metal smelting and electrorefining processes using the Robot System of claim 1 to 13, wherein the anthropomorphous robotic manipulator could communicate by itself or through a PLC interface with the control system.

16. A robotic method the anthropomorphous robotic manipulator could communicate by itself or through a PLC interface with the control system 1 to 13, wherein the anthropomorphous robotic manipulator has the capacity to obtain and interpret the information from installed analogue and/or digital sensors.

17. A robotic method the anthropomorphous robotic manipulator could communicate by itself or through a PLC interface with the control system 1 to 13, wherein the anthropomorphous robotic manipulator has the capacity to generate analogue and/or digital signals to control the analogue and/or digital inputs devices.

18. A robotic method the anthropomorphous robotic manipulator could communicate by itself or through a PLC interface with the control system 1 to 13, wherein it allows the final user of this technology to use the system in a modular way, allowing to carry out the surface inspection and burr elimination in a selective, independent, separate or supplementary way.

19. A robotic method for the elimination of burrs and/or surface inspection in anodes in metal smelting and electrorefining processes using the robot System of claim 1 to 13, it allows the technology final user to use one or two of the activities of anode surface inspection and/or burr elimination, in a selective or supplementary way, according to the requirements.

20. A robotic method for the elimination of burrs and/or surface inspection in anodes in metal smelting and electrorefining processes using the robot System of claim 1 to 13, wherein the robotic manipulator of at least 4 degrees of freedom is provided with a gripping mechanism which allows to take, manipulate and release, in a sequential and programmed way, an advanced vision system for anode surface inspection over different paths within the work volume of the robotic system.

21. A robotic method for the elimination of burrs and/or surface inspection in anodes in metal smelting and electrorefining processes using the robot System of claim 1 to 13, wherein the anthropomorphous robotic arm of at least 4 degrees of freedom has a pneumatic gripping mechanism to take, manipulate and release a burr elimination device.

22. A robotic method for the elimination of burrs and/or surface inspection in anodes in metal smelting and electrorefining processes using the robot System of claim 1 to 13, wherein the anthropomorphous robotic manipulator has an electrical system driven by three-stage induction motors with vectorial and/or scalar control.

23. A robotic method for the elimination of burrs and/or surface inspection in anodes in metal smelting and electrorefining processes using the robot System of claim 1 to 13, wherein productivity and efficiency of anode surface inspection and burr elimination increases.

24. A robotic method for the elimination of burrs and/or surface inspection in anodes in metal smelting and electrorefining processes using the robot System of claim 1 to 13, wherein it could be integrated not only to anode surface inspection and burr elimination processes of different metals such as copper, zinc, Ni, Fe, etc., but also it could be used for the surface inspection and burr elimination in a selective and supplementary way in a wide range of other industrial productive processes

25. A robotic method for the elimination of burrs and/or surface inspection in anodes in metal smelting and electrorefining processes using the robot System of claim 1 to 13, wherein it has the capacity to move and manipulate the different tools in different paths within the work volume of the robotic manipulator.

26. A robotic method for the elimination of burrs and/or surface inspection in anodes in metal smelting and electrorefining processes using the robot System of claim 1 to 13, wherein the system may operate automatically or semi-automatically, and also allows solution scalability.
